(19) United States
(12) Patent Application Publication
(10) Pub. No.: US 2002/0193980 A1
(43) Pub. Date: Dec. 19, 2002

(54) Semiconductor test program debugging apparatus

(76) Inventors: Shinsaku Higashi, Tokyo (JP); Takahiro Kataoka, Tokyo (JP)

Correspondence Address: DELLETT AND WALTERS, 310 S.W. FOURTH AVENUE, SUITE 1101, PORTLAND, OR, 97204, US

(21) Appl. No.: 10/142,256

(22) Filed: May 8, 2002

(30) Foreign Application Priority Data
May 10, 2001 (JP) 2001-139623

(51) Int. Cl. G06F 9/455

(52) U.S. Cl. 703/26

(57) ABSTRACT

A semiconductor test program debugging apparatus is provided which generates, in a simulatory manner, a signal that a DUT should output when receiving a test signal, and which generates, in a simulatory manner, an analog waveform that should be output from the analog output terminal, when an analog waveform acquisition instruction that is included in a semiconductor test program has been executed.

### BACKGROUND OF THE INVENTION

The present invention relates to a semiconductor test program debugging apparatus for checking a semiconductor test program by emulating an operation of a semiconductor test apparatus.

Semiconductor test apparatuses are known that perform a DC test, a function test, etc. on various semiconductor devices such as logic ICs and semiconductor memories before shipment. The tests that are performed by semiconductor test apparatuses are generally classified into the function test and the DC test. In a function test, a prescribed test pattern signal is applied to a semiconductor device to be tested (hereinafter referred to as “DUT”) and it is checked whether the DUT performs an expected operation for the test pattern signal. In a DC test, it is checked whether DC characteristics obtained at each terminal of a DUT are expected ones.

In recent years, many semiconductor devices having analog output terminals have been developed as exemplified by semiconductor devices used in cellular phones. And there are semiconductor test apparatuses in which a function of capturing an analog output waveform of such a semiconductor device is added. Equipped with analog-to-digital (A/D) converter, these semiconductor test apparatuses can capture voltage values of an analog output waveform discretely at a prescribed sampling frequency. Various analyses such as a frequency analysis are performed based on the thus-acquired data of the analog output waveform.

In conducting a function test or a DC test mentioned above, various conditions, that is, tests of what measurement items are to be performed under what conditions are incorporated in advance in a semiconductor test program. Therefore, various tests can be performed on a DUT by running such a semiconductor test program. However, a semiconductor test program includes an enormous number of steps because it is required to control a wide variety of operations such as setting of test items, setting of test conditions, execution of a test, and judgment of a test result. When the kind of a DUT or its logic is changed, it is necessary to alter a semiconductor test program accordingly in various manners. When a semiconductor test program is newly generated or altered, it is necessary to evaluate it, that is, to check whether the program itself operates normally.

One method is such that a semiconductor test program is evaluated by running it for a DUT that is known to be good or defective by using an actual semiconductor test apparatus. However, semiconductor test apparatuses themselves are expensive and are introduced in a small number. Therefore, testing whether a semiconductor test program operates normally by using an actual semiconductor test apparatus requires that operation of a semiconductor test line be stopped and hence is not preferable. In view of the above, conventionally, instead of evaluating a semiconductor test program by using an actual semiconductor test apparatus, whether the semiconductor test program operates normally is checked by emulating the operation of the semiconductor test apparatus by using a general-purpose computer such as a workstation.

Among apparatuses for emulating the operation of a semiconductor test apparatus is a debugging apparatus disclosed in Japanese Patent Laid-Open No. 9-185519. This debugging apparatus generates waveform data that complies with test conditions and is to be applied to each measurement subject pin (evaluation subject pin) of a DUT in the same manner as a real semiconductor test apparatus would do in testing the DUT. Output waveform data that would be output from an output pin when waveform data thus generated is applied to each input pin of the DUT is generated in a simulatory manner. A pass/fail judgment is made by comparing the output waveform data with test conditions. A judgment result is stored in a test result storage section, and compared with a test result expectation value, whereby it is checked whether a semiconductor test program operates normally.

Incidentally, the above conventional debugging apparatus merely generates output waveform data having a fixed value for each pin of a DUT and makes a pass/fail judgment according to test conditions using this value. This results in a problem that where the measurement subject is a DUT having an analog output terminal like, for example, a semiconductor device used in a cellular phone and a semiconductor test program includes an instruction to capture voltage values of an analog output waveform, the semiconductor test program cannot be checked for that instruction.

### SUMMARY OF THE INVENTION

The present invention has been made in view of the above circumstances, and an object of the invention is therefore to provide a semiconductor test program debugging apparatus capable of checking a semiconductor test program produced for a semiconductor device having an analog output terminal.

To debug a semiconductor test program to be used for testing a DUT having an analog output terminal, a semiconductor test program debugging apparatus according to a preferred embodiment of the invention comprises a tester emulating unit, a device model unit, and an analog waveform generating unit. The tester emulating unit is for emulating an operation of a semiconductor test apparatus by generating a test signal that should be input to the DUT in a simulatory manner based on the semiconductor test program. The device model unit generates, in a simulatory manner, an output signal that the DUT should output in response when receiving the test signal. The analog wave form generating unit generates, in a simulatory manner, an analog waveform that should be output from the analog output terminal, when an acquisition instruction to acquire voltage values that should appear at the analog output terminal has been executed, the acquisition instruction being included in the semiconductor test program. When the acquisition instruction to acquire an analog output waveform of the DUT has been executed, a desired analog waveform is generated in a simulatory manner, whereby a state of capturing this analog waveform is reproduced. Therefore, the semiconductor test program produced for the semiconductor device having the analog output terminal can be checked.

It is desirable that the debugging apparatus further comprise an emulator control unit for analyzing the contents of various instructions included in the semiconductor test program when the semiconductor test program is executed and supplying operation instructions corresponding to the respective instructions to the tester emulating unit, and for analyzing the contents of the acquisition instruction and supplying the analog waveform generating unit with an instruction to generate the analog waveform in a simulatory manner. Since the generation of the analog waveform is started when the acquisition instruction has been executed actually and its contents have been analyzed, it is appropriate to generate the analog waveform in a simulatory manner with the same timing as the analog waveform would be acquired in a real semiconductor test apparatus. Therefore, the amount of calculation that is necessary to generate the analog waveform can be reduced.

It is desirable that a file describing a relationship between the elapsed time and the generation voltage be stored in the analog waveform generating unit, and the analog waveform generating unit generates the analog waveform in a simulatory manner based on the file. A waveform having any shape can be generated only by specifying a relationship between the elapsed time and the voltage value in advance, and hence even a complex waveform can be generated easily.

It is desirable that a function that defines a shape of the analog waveform be registered in the analog waveform generating unit, and the analog waveform generating unit generates the analog waveform in a simulatory manner by calculating values of the function that correspond to respective elapsed times. Since an analog waveform can be generated only by defining a function, the amount of data that are necessary to generate an analog waveform can be reduced.

It is desirable that the function that defines a shape of the analog waveform be formed by combining a plurality of trigonometric functions. In this case, an analog waveform having an arbitrary amplitude, frequency, and phase can be generated easily.

It is also desirable that the function be formed by using a built-in function of the C language. In this case, the number of steps of program development can be decreased by using existing built-in functions.

It is desirable that the tester emulating unit comprises an analog waveform capturing unit for capturing, at intervals of a prescribed sampling period, the analog waveform generated by the analog waveform generating unit in a simulatory manner in response to the acquisition instruction. In this case, whether the acquisition instruction included in the semiconductor test program has been executed normally can be checked.

It is desirable that the sampling period be specified in the semiconductor test program, and the analog waveform generating unit generates the analog waveform in a simulatory manner at intervals of the sampling period. Equalizing the interval of generation of the analog waveform with that of capturing of the analog waveform makes it possible to reliably generate the analog waveform whenever necessary as well as simplify the processing.

It is desirable that the analog waveform generating unit calculate a generation voltage value corresponding to an elapsed time that is not included in the elapsed times stored in the file by performing interpolation based on elapsed times and generation voltages listed in the file. In this case, the number of pairs of an elapsed time and a generation voltage and hence the amount of data of the file can be reduced.

### BRIEF DESCRIPTION OF THE DRAWINGS

FIG. 1 shows the entire configuration of a semiconductor test program debugging apparatus according to an embodiment of the present invention;

FIG. 2 shows the entire configuration of a real semiconductor test apparatus;

FIG. 3 shows a specific example of a table showing a relationship between the elapsed time and the generation voltage;

FIG. 4 shows specific contents of a file containing the table of FIG. 3;

FIG. 5 shows a specific example of a function that is registered in a function registration section; and

FIG. 6 shows a specific example of an analog output waveform acquisition instruction that is included in an actual device test program.

### DESCRIPTION OF THE PREFERRED EMBODIMENT

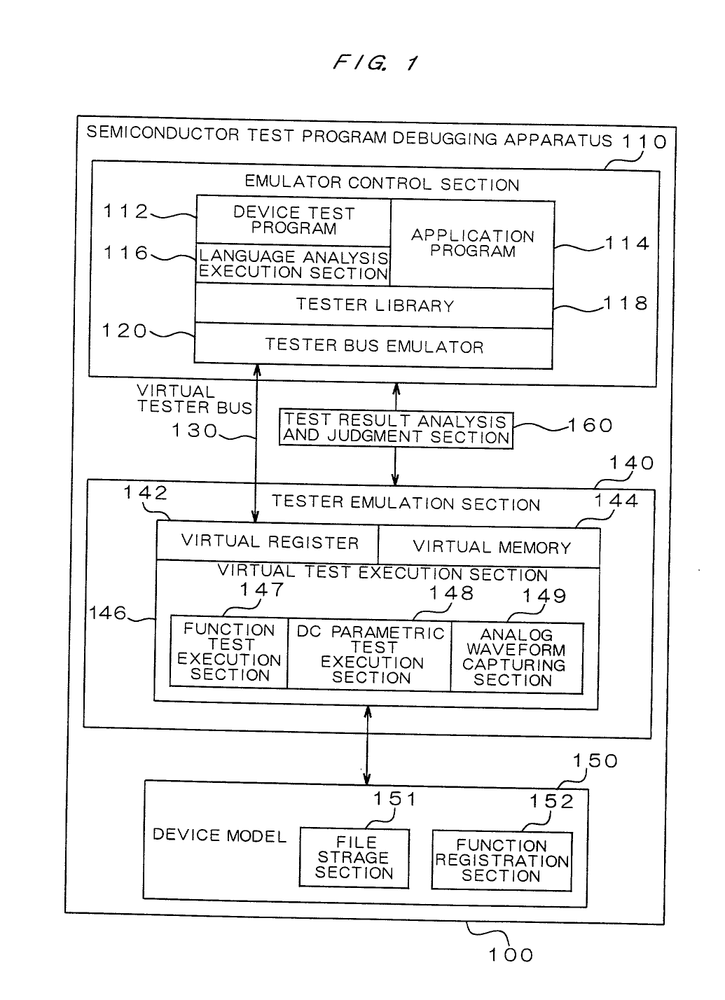

A semiconductor test program debugging apparatus according to an embodiment will be hereinafter described with reference to the accompanying drawings. FIG. 1 shows the entire configuration of the semiconductor test program debugging apparatus (hereinafter referred to as “debugging apparatus” simply). The debugging apparatus 100, which is implemented by a general-purpose computer such as a workstation, serves to check whether a semiconductor test program operates normally by emulating an operation of a semiconductor test apparatus and simulating an operation of a semiconductor device under test (DUT).

The debugging apparatus 100 according to the embodiment emulates or simulates operations of an actual semiconductor test apparatus and DUT. Therefore, before describing the debugging apparatus in detail, the rough configuration of a semiconductor test apparatus to be emulated will be described.

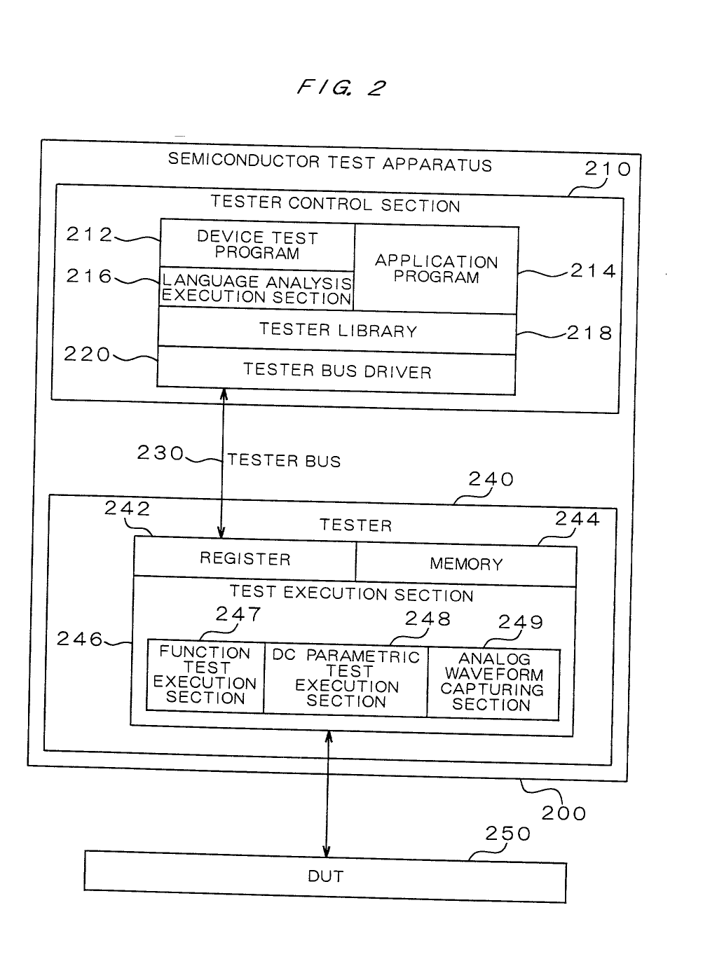

FIG. 2 shows the entire configuration of an actual semiconductor test apparatus. FIG. 2 shows a state that an actual DUT 250 is mounted to a semiconductor test apparatus 200. The semiconductor test apparatus 200 performs various DC tests (DC parametric tests) and function tests on the DUT 250, and has a function of capturing an analog output waveform of the DUT 250 when it has an analog output terminal. To this end, the semiconductor test apparatus 200 includes a tester control section 210, a tester 240, and a socket section (not shown) to be mounted with the DUT 250.

The tester control section 210, which controls operation of the tester 240, includes a semiconductor test program (device test program) 212, an application program 214, a language analysis execution section 216, a tester library 218, and a tester bus driver 220.

The device test program 212 describes a procedure and a method of a test that a user intends to perform on the DUT 250 by using the semiconductor test apparatus 200. In general, this type of device test program is 212 developed and generated by the user of the semiconductor test apparatus 200. The user can generate a device test program 212 that is very close to completion by checking whether the user-generated device test program 212 operates normally by using the debugging apparatus 100 according to the embodiment rather than the actual semiconductor test apparatus 200. The device test program 212 includes an acquisition instruction to capture an analog waveform that is output from the DUT 250.

The language analysis execution section 216, which performs parsing etc. on the device test program 212, plays a central role in causing the semiconductor test apparatus 200 to operate faithfully according to the device test program 212. The application program 214, which operates in cooperation with the device test program 212 and the language analysis execution section 216, applies an actual test signal etc. corresponding to various tests such as a function test to the DUT 250, capturing an output signal of the DUT 250, and judging whether the subject DUT 250 is good or defective and analyzes its characteristics.

The tester library 218 converts the instructions of the device test program 212 that have been obtained by parsing by the language analysis execution section 216 into register-level instructions (i.e., data relating to an instruction to write data to registers 242 and an instruction to read data from the registers 242 (described later)), whereby the test library 218 generates and sets data that are necessary for operation of the semiconductor test apparatus 200 and instructs the tester 240 on a measurement operation. The tester bus driver 220 transfers the data generated by the tester library 218 to the registers 242 of the tester 240 via the tester bus 230.

The tester 240 performs various tests on the DUT 250 based on data that are captured from the tester control section 210 via the tester bus 230. When necessary, the tester 240 captures voltage values of an analog waveform that is output from the analog output terminal of the DUT 250. To this end, the tester 240 includes the registers 242, a memory 244, and a test execution section 246. The registers 242 store the data that are captured from the tester library 218 via the tester bus 230. The data stored in the registers 242 are output to the test execution section 246 directly or via the memory 244. The registers 242 and the memory 244 have a test result storage area (not shown) where to store data relating to a test result that are supplied from the test execution section 246.

The test execution section 246 has a function test execution section 247, a DC parametric test execution section 248, and an analog waveform capturing section 249. The function test execution section 247 performs a function test on the DUT 250 based on data that have been supplied from the tester library 218 and stored in the registers 242 or the memory 244, and stores test result data in a test result storage area of the registers 242 or the memory 244. Similarly, the DC parametric test execution section 248 performs a DC parametric test on the DUT 250 based on data that have been supplied from the tester library 218 and stored in the registers 242 or the memory 244, and stores test result data in the test result storage area of the registers 242 or the memory 244. The analog waveform capturing section 249 captures voltage values of an analog waveform that is output from the analog output terminal of the DUT 250 at prescribed sampling intervals, and stores, in the test result storage area of the memory 244, analog waveform data obtained by analog-to-digital-converting (A/D-converting) the captured voltage values. The test result data and analog waveform data that have been stored in the registers 242 and the memory 244 in the above-described manners are caused by the tester bus driver 220 to be captured directly by the tester library 218 via the tester bus 230. The tester library 218 via the register 242 captures the data stored in the memory 244.

The debugging apparatus 100 of FIG. 1 emulates the entire operation of the above-described semiconductor test apparatus 200 and simulates an operation of the DUT 250. Therefore, by running, by using the debugging apparatus 100 of FIG. 1, the device test program 112 (212) that was generated for the semiconductor test apparatus 200, it can be checked whether the operation of the device test program 112 coincides with the operation intended by the user. Next, the configuration of the debugging apparatus 100 according to the embodiment will be described.

As shown in FIG. 1, the debugging apparatus 100 according to the embodiment is equipped with an emulator control section 110, a tester emulation section 140, a device model 150, and a test result analysis and judgment section 160. The emulator control section 110 corresponds to an emulator control unit, the tester emulation section 140 corresponds to a tester emulating unit, and the device model 150 corresponds to a device model unit and an analog waveform generating unit, respectively.

An emulator control section 110 includes a device test program 112, an application program 114, a language analysis execution section 116, a tester library 118, and a tester bus emulator 120. The emulator control section 110, which controls operation of a tester emulation section 140, performs basically the same operation as the tester control section 210 of the semiconductor test apparatus 200 shown in FIG. 2.

The device test program 112, which is a program to be debugged by the debugging apparatus 100, describes a procedure and a method of a test to be performed on the DUT 250 by using the semiconductor test apparatus 200. Therefore, the device test program 212 shown in FIG. 2 is ported, as it is, to serve as the device test program 112 and operate in the same manner. Similarly, for the application program 114, the language analysis execution section 116, and the tester library 118, the application program 214, the language analysis execution section 216, and the tester library 218 shown in FIG. 2 are ported as they are and operate in the same manners.

The tester bus emulator 120 drives a virtual tester bus 130 that imaginarily connects the emulator control section 110 to the tester emulation section 140, and controls data exchange between the tester library 118 and the tester emulation section 140 via the virtual tester bus 130.

The tester emulation section 140, which is a software-implemented version of the tester 240 shown in FIG. 2, performs a simulatory test on a device model 150 according to operation commands that are supplied from the tester library 118 of the emulator control section 110. The tester emulation section 140 includes virtual registers 142, a virtual memory 144, and a virtual test execution section 146. The virtual registers 142 store data that are supplied from the tester library 118. The data stored in the virtual registers 142 are sent to the virtual test execution section 146 directly or via the virtual memory 144. The virtual registers 142 and the virtual memory 144 have a test result storage area (not shown) where to store the data of virtual test result that are output from the virtual test execution section 146.

The virtual test execution section 146 has a function test execution section 147, a DC parametric test execution section 148 and an analog waveform capturing section 149. The virtual test execution section 146 causes the function test execution section 147 to perform a function test or causes the DC parametric test execution section 148 to perform a DC parametric test on the device model 150 by outputting a prescribed waveform data to be applied to the device model 150 based on the data that have been supplied from tester library 118 and are stored in the virtual registers 142, and stores the data of virtual test result in the test result storage area of the virtual registers 142 or the virtual memory 144. When an analog waveform has been generated in a simulatory manner by the device model 150, the analog waveform capturing section 149 captures the analog waveform at prescribed sampling intervals. Captured analog waveform data are stored in the test result storage area of the virtual memory 144. The virtual test result data and the analog waveform data stored in the virtual registers 142 and the virtual memory 144 are output to the tester library 118 via the virtual tester bus 130.

A test result analysis and judgment section 160 examines and compares each other the data of virtual test result stored in the virtual registers 142, the virtual memory 144, or the tester library 118 and a test result expectation value that is expected in advance, judges whether the device test program 112 operates normally, and displays a judgment result to the user. For example, if an erroneous test result is obtained as a result of execution of the device test program 112, the test result analysis and judgment section 160 displays a line number or the like of the program that caused the erroneous test result on a monitor (not shown) or print it out. The test result analysis and judgment section 160 performs the above-described check processing for the function test and the DC parametric test and does not perform any checks based on the captured analog waveform data. A check based on the analog waveform data is performed by the device test program 112 that is generated by the user.

In the debugging apparatus 100 according to the embodiment, the device test program 112 includes the acquisition instruction to capture an analog output waveform. When the acquisition instruction is executed, the device model 150 generates an analog output waveform in a simulatory manner. To this end, the device model 150 is equipped with a file storage section 151 and a function registration section 152. In the embodiment, an analog output waveform is generated in a simulatory manner using two kinds of techniques. The file storage section 151 is used in one technique and the function registration section 152 is used in the other technique.

FIG. 3 shows a specific example of a table showing a relationship between the elapsed time and the generation voltage. In FIG. 3, “t” represents the elapsed time and character “V” represents the analog waveform voltage value (instantaneous value) corresponding to the elapsed time t. Holding the relationship between the elapsed time and the voltage value in table form in this manner makes it possible to easily determine the shape of the analog waveform. If an elapsed time at which an analog waveform voltage value is to be generated is not listed on the table, a voltage value may be determined by performing interpolation based on elapsed times and voltage values on the table. A voltage value corresponding to an arbitrary elapsed time can be determined in this manner. Capable of decreasing the number of pairs of an elapsed time and a voltage value on the table, such interpolation processing can reduce the amount of data of the table.

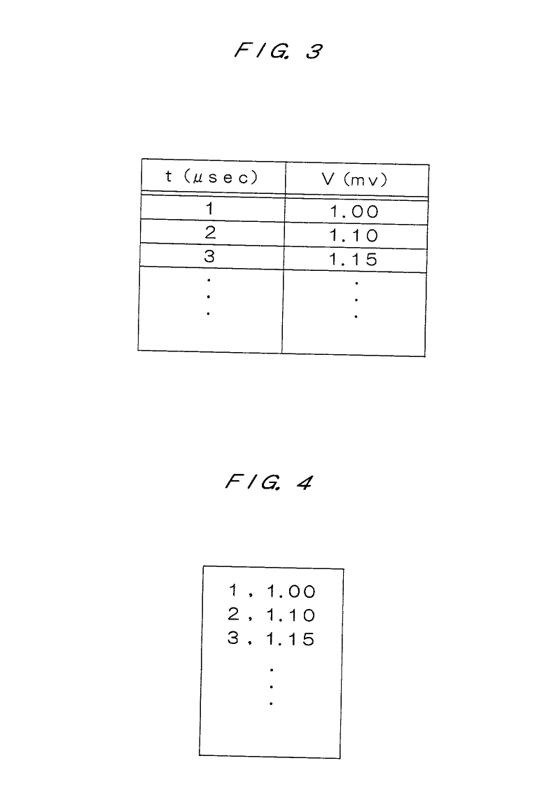

FIG. 4 shows specific contents of a file containing the table of FIG. 3. For example, as shown in FIG. 4, the contents of the table of FIG. 3 are described by a text file containing a necessary number of pairs of text data in each of which a comma (,) is interposed between an elapsed time and a voltage value. The device model 150 reads this file from the file storage section 151 with prescribed timing, and generates an analog waveform in a simulatory manner based on the relationship between the elapsed time and the voltage value that is given by this file.

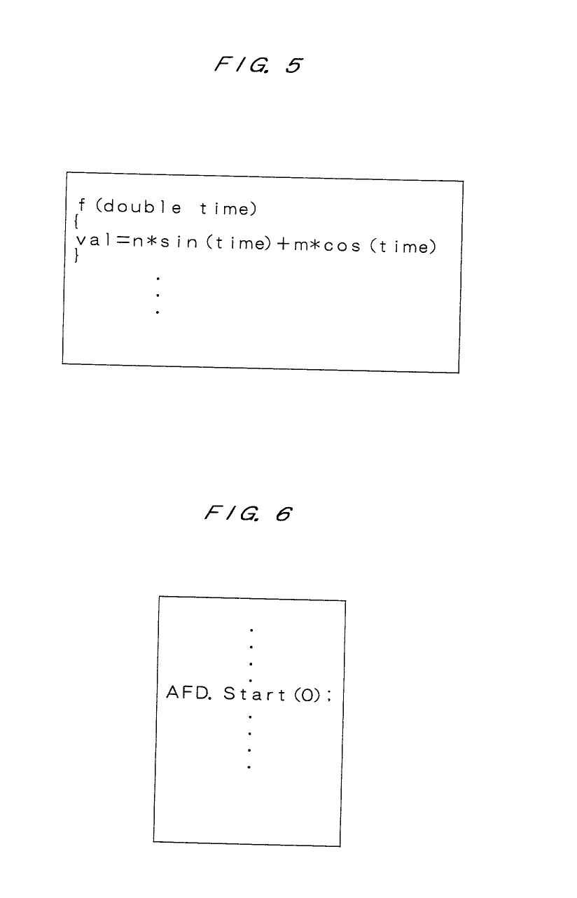

FIG. 5 shows a specific example of a function that is registered in the function registration section 152. In FIG. 5, “f” represents a function that has been defined by the user. For example, a function value “val” is defined by using existing functions or combining arbitrary formulae with a double-precision elapsed time “double time” used as a parameter. For example, the existing functions are built-in functions and the like that are prepared in various programming languages. The example of FIG. 5 uses trigonometric functions (sin and cos) that are prepared in the C language. Using existing built-in functions in this manner can decrease the number of steps of program development. Since an arbitrary waveform can be created by combining a plurality of trigonometric functions, trigonometric functions are considered most suitable for the above-mentioned existing functions. However, other functions may be used. Where a relatively simple function such as a linear function or a quadratic function is to be used, a function may be defined by using a linear formula, a quadratic polynomial, or the like that uses a time variable “time.” The device model 150 generates an analog waveform in a simulatory manner by reading a defined function from the function registration section 152 with prescribed timing and calculates values “val” of the function f corresponding to respective elapsed times.

In this manner, analog waveform data can be obtained that are similar to those as would be produced in the case where the analog waveform capturing section 249 of the semiconductor test apparatus 200 captures an analog waveform that is actually output from the DUT 250.

FIG. 6 shows a specific example of the analog output waveform acquisition instruction that is included in the actual device test program 112. When the acquisition instruction “AFD.Start (0)” has been executed and its contents has been analyzed by the language analysis execution section 116, the tester library 118 instructs the tester bus emulator 120 to capture an analog output waveform. The tester bus emulator 120 supplies the contents of this instruction to tester emulation section 140 via the virtual tester bus 130. In response to this instruction, the analog waveform capturing section 149 that is provided in the virtual test execution section 146 of the tester emulation section 140 captures an analog waveform that is generated by the device model 150.

Parallel with the above operation of the tester emulation section 140, the device model 150 generates an analog waveform in a simulatory manner based on the contents of a file stored in the file storage section 151 in advance or the contents of the definition of a function that is registered in the function registration section 152 in advance. Actual capturing of the analog waveform by the analog waveform capturing section 249 is performed at intervals of a sampling period that was specified by the user in advance. Therefore, the device model 150 calculates analog waveform data at intervals of the sampling period.

As described above, in the debugging apparatus 100 according to the embodiment, in the case where the device test program 112 as a subject of debugging includes an acquisition instruction to capture an analog output waveform of the DUT 250, an analog waveform is generated in a simulatory manner in response to execution of the acquisition instruction. Therefore, the device test program 112 corresponding to the acquisition instruction can be checked reliably.

In particular, where a file that describes, in table form, a relationship between the elapsed time and the voltage value of an analog waveform is stored in the file storage section 151 in advance and an analog waveform is generated in a simulatory manner based on the file, any waveform can be generated only by specifying the relationship between the elapsed time and the voltage value in advance. Therefore, even a complex waveform can be generated easily.

Where a function is defined and registered in the function registration section 152 in advance and an analog waveform is generated in a simulatory manner based on the registered function, the amount of data that are necessary to generate an analog waveform can be reduced.

The invention is not limited to the above embodiment and various modifications are possible without departing from the spirit and scope of the invention. For example, although in the table of FIG. 3 the elapsed times have regular intervals, they may have irregular intervals. The elapsed times may have any values as long as waveform voltage values at time points between the elapsed times can be interpolated by using the elapsed times and corresponding voltage values.

Although in the above embodiment the device model 150 is equipped with both of the file storage section 151 and the function registration section 152, the device model 150 may be only equipped with one of those.

Although in the above embodiment the device model 150 generates an analog waveform in a simulatory manner, another section, for example, the analog waveform capturing section 149 of the virtual test execution section 146, may do so.

1. A semiconductor test program debugging apparatus for debugging a semiconductor test program to be used for testing a DUT having an analog output terminal, comprising:
a tester emulating unit for emulating an operation of a semiconductor test apparatus by generating a test signal that should be input to said DUT in a simulatory manner based on said semiconductor test program;
a device model unit for generating, in a simulatory manner, an output signal that said DUT should output in response when receiving said test signal; and
an analog waveform generating unit for generating, in a simulatory manner, an analog waveform that should be output from said analog output terminal, when an acquisition instruction to acquire voltage values that should appear at said analog output terminal has been executed, said acquisition instruction being included in said semiconductor test program.

2. The semiconductor test program debugging apparatus according to claim 1, further comprising an emulator control unit for analyzing contents of various instructions included in said semiconductor test program when said semiconductor test program is executed and supplying operation instructions corresponding to said respective instructions to said tester emulating unit, and for analyzing contents of said acquisition instruction and supplying said analog waveform generating unit with an instruction to generate said analog waveform in a simulatory manner.

3. The semiconductor test program debugging apparatus according to claim 1, wherein a file describing a relationship between elapsed times and generation voltages is stored in said analog waveform generating unit, and said analog waveform generating unit generates said analog waveform in a simulatory manner based on said file.

4. The semiconductor test program debugging apparatus according to claim 1, wherein a function that defines a shape of said analog waveform is registered in said analog waveform generating unit, and said analog waveform generating unit generates said analog waveform in a simulatory manner by calculating values of said function that correspond to respective elapsed times.

5. The semiconductor test program debugging apparatus according to claim 4, wherein said function is formed by combining a plurality of trigonometric functions.

6. The semiconductor test program debugging apparatus according to claim 4, wherein said function is formed by using a built-in function of the C language.

7. The semiconductor test program debugging apparatus according to claim 1, wherein said tester emulating unit comprises an analog waveform capturing unit for capturing, at intervals of a prescribed sampling period, said analog waveform generated by said analog waveform generating unit in a simulatory manner in response to said acquisition instruction.

8. The semiconductor test program debugging apparatus according to claim 7, wherein said sampling period is specified in said semiconductor test program by said analog waveform capturing unit, and said analog waveform generating unit generates said analog waveform in a simulatory manner at intervals of said sampling period.

9. The semiconductor test program debugging apparatus according to claim 3, wherein said analog waveform generating unit calculates a generation voltage value corresponding to an elapsed time that is not included in said elapsed times stored in said file by performing interpolation based on elapsed times and generation voltages listed in said file.
